(19) United States
(12) Patent Application Publication
(10) Pub. No.: US 2011/0068548 A1
(43) Pub. Date: Mar. 24, 2011

(54) Transport pallet

(76) Inventors: Ronald L. Houggard, Morgan Hill, CA (US); Lloyd L. Hudson, Reno, NV (US)

(21) Appl. No.: 12/586,611

(22) Filed: Sep. 23, 2009

(51) Int. Cl. B60P 9/00; B65D 19/06; B62D 63/06

(52) U.S. Cl. 280/43.17; 280/79.2

(57) ABSTRACT

A transport pallet assembly that can safely and easily transport large and heavy equipment of a character that is both delicate and temperature sensitive. The assembly is specially designed to safely and easily transport and store highly sensitive and easily damaged scientific equipment such as large, sophisticated lithograph machines.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF INVENTION

1. Field of the Invention

The present invention relates generally to transport pallets. More particularly, the invention relates to a transport pallet assembly for safely transporting large, very sensitive equipment such as large optical scanners.

2. Description of Related Art Including Information Disclosed under 37 CFR 1.97 and 1.98

Pallets of the number of different designs have been developed in the past for use in the loading and transport of equipment of various types, for use in stacking of various types of bulk items for transportation and storage, and for use in connection with various types of agricultural and industrial endeavors. The typical prior art pallet is generally constructed from inexpensive materials such as wood and plastic.

The prior art fails to address the need to provide pallets that are capable of safely and conveniently storing and transporting large, very sensitive and easily damaged equipment such as sophisticated optical devices, including optical devices such as complex step and repeat scanning systems. It is this need that the present invention seeks to address.

### BRIEF SUMMARY OF INVENTION

By way of brief summary, the transport pallet of the present invention comprises a base assembly including frame having interconnected side and end walls; a plurality of spaced apart stiffener members connected to and spanning the end walls of the frame; a plurality of ground engaging roller assemblies connected to the frame and extending there from; and a novel article support assembly connected to said base assembly, the article support assembly including a support panel and a plurality of resilient, energy dissipating shock and vibration isolators connected to the support panel.

With the forgoing in mind, it is an object of the present invention to provide novel transport pallet assembly that can safely and easily transport large and heavy equipment of a character that is both delicate and temperature sensitive. More particularly, it is an object of the invention to provide a novel transport pallet assembly that can safely and easily transport and store highly sensitive and easily damaged scientific equipment such as large, sophisticated lithograph machines.

Another object of the invention is to provide a novel transport pallet assembly of the character described that is reusable and one that can readily be employed to transport large and heavy equipment in climate controlled trucks and aircraft.

Another object of the invention is to provide a novel transport pallet assembly as described in the preceding paragraph that can be easily loaded onto trucks and large airplanes without damaging the cargo truck, or airplane.

Another object of the invention is to provide a novel transport pallet assembly of the class described in which the cargo to be transported is supported during transport on a plurality of novel shock and vibration absorption members that comprise resilient, energy dissipating isolators of unique design.

Another object of the invention is to provide a novel transport pallet assembly of the aforementioned character that can safely carry cargo weighing up to 22,050 pounds (10,000 kg).

Another object of the invention is to provide a novel transport pallet assembly as described in the preceding paragraphs that can be easily raised and lowered and smoothly rolled from place to place.

Another object of the invention is to provide a novel transport pallet assembly of the class described in which the cargo can be positively secured to the pallet during transport.

The forgoing objectives as well as other objectives will be achieved by the novel transport pallet assembly illustrated in the drawings and described in the following paragraphs.

### BRIEF DESCRIPTION OF SEVERAL VIEWS OF THE DRAWINGS

FIG. 1 is a generally perspective view of one form of the pallet assembly of the present invention shown in supporting a large piece of highly sensitive optical scanning equipment.

FIG. 2 is a generally perspective view of the pallet assembly shown in FIG. 1 of the drawings as it appears prior to the equipment being placed on the pallet.

FIG. 2A is a generally perspective exploded view of the pallet assembly shown in FIG. 2.

FIG. 3 is a generally perspective view of the base assembly of the apparatus shown in FIG. 2 of the drawings.

FIG. 4 is a top plan view of the base assembly shown in FIG. 3 of the drawings.

FIG. 5 is a generally perspective exploded view of the article support assembly of the apparatus shown in FIG. 2 of the drawings.

FIG. 6 is an end view of the article support assembly shown in FIG. 5.

FIG. 7 is a side elevational view of the article support assembly shown in FIG. 5.

FIG. 8 is a generally perspective view of one form of the energy dissipating shock and vibration isolators of the article support assembly shown in FIG. 5.

FIG. 9 is a generally perspective front view of one form of jack screw skate assembly of the base assembly shown in FIG. 3.

FIG. 10 is a generally perspective rear view of the jack screw skate assembly.

FIG. 11 is a generally diagrammatic view illustrating one method for removing cargo and article support assembly from the transport pallet.

FIG. 12 is a generally perspective view showing a plurality of the pallet assemblies as they appear in a stacked relationship.

FIG. 13 is a side elevational view of the plurality of the pallet. assemblies with the jack screw skate assemblies as they appear in a stacked relationship.

### DETAILED DESCRIPTION OF THE INVENTION

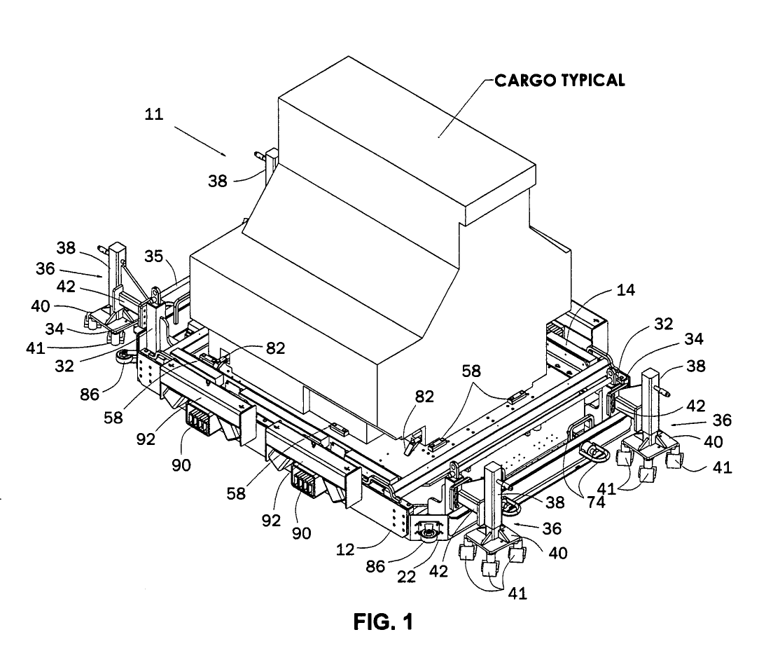

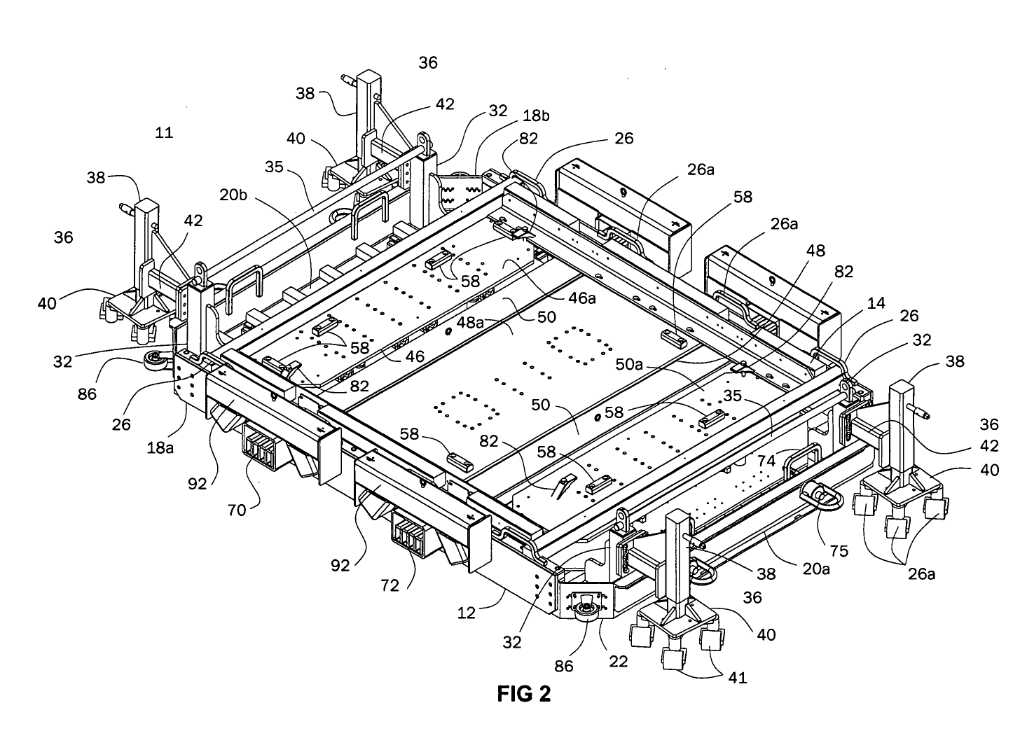

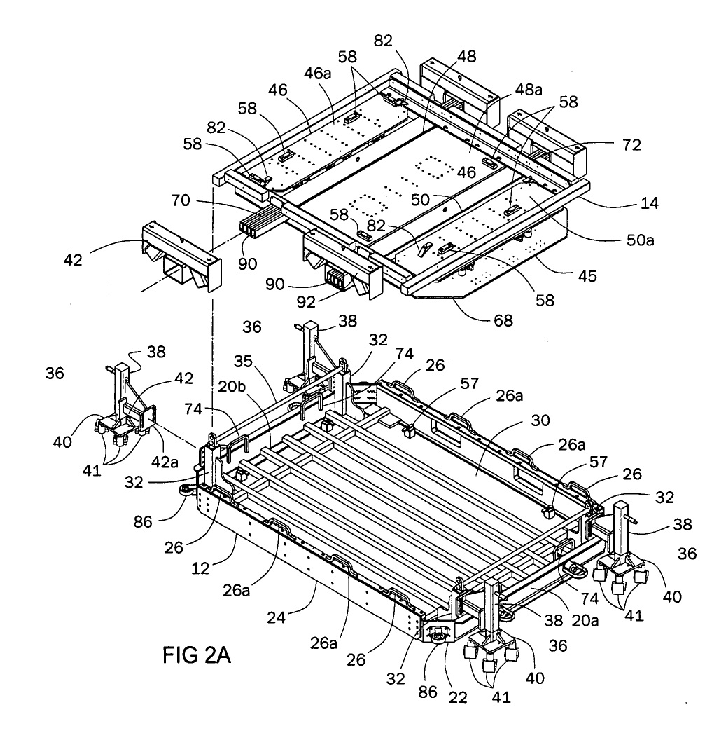

Referring to the drawings and particularly to FIGS. 1 and 2, one form of the pallet assembly of the present invention is there illustrated and generally designated by the numeral 11. Pallet assembly 11 here comprises a base assembly 12 and an article support assembly 14 that is connected to base assembly 12 in the manner shown in FIG. 2 of the drawings.

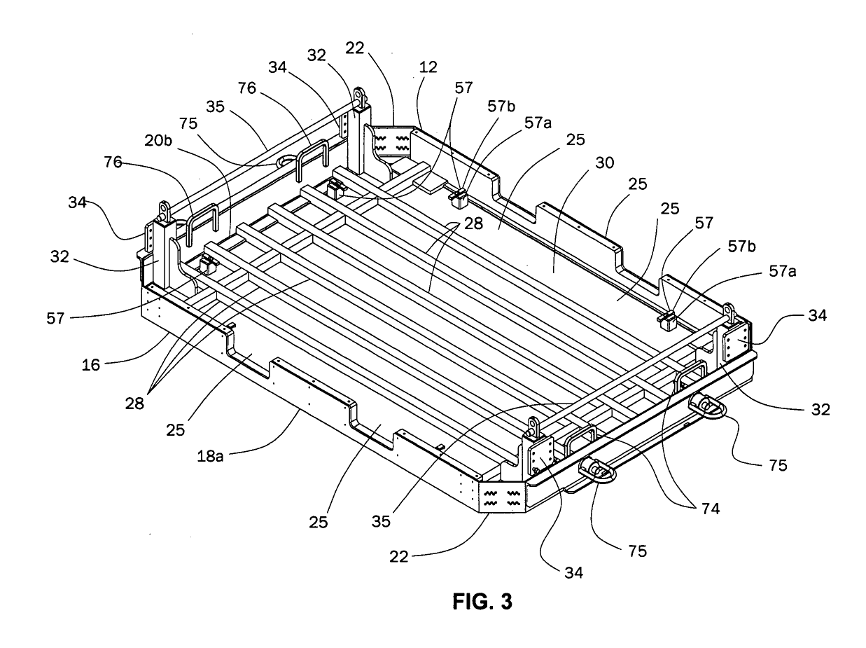

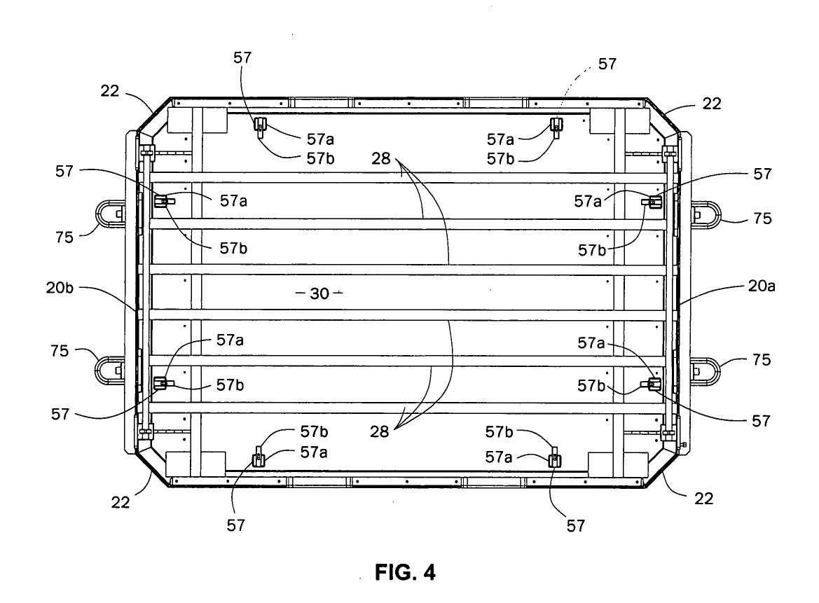

As best seen in FIG. 3 of the drawings, base assembly 12 includes a frame 16 having side walls 18a and 18b and end walls 20a and 20b respectively. Provided at the juncture of the side and end walls are angularly extending wall segments 22 (FIG. 4). As best seen by referring to FIG. 2A of the drawings, each of the side walls includes a cover plate 24 that is removable to expose a pair of spaced apart, generally U-shaped openings 25 (FIG. 3). Welded to the top of each cover plate are four inverted U-shaped brackets 26 that can be used as tie down points. The two center brackets 26a can also be used to pick up the heavy cover plate using a forklift. Connected to and spanning end walls of the frame is a plurality of spaced apart stiffener members 28, the purpose of which will presently be described. Spaced apart stiffener members 28 are superimposed over a base panel 30 that is also connected to and spans end walls 20a and 20b.

Interconnected with each of the end walls of the frame are upstanding members 32 to which connector plates 34 are interconnected (FIGS. 3 and 4). Connected to and spanning each pair of upstanding members 32 is a transversely extending rod 35 that functions to stabilize the upstanding members 32.

Also forming a part of base assembly 12 is a plurality of ground engaging roller assemblies 36 that are connected to connector plates 34 in the manner illustrated in FIGS. 1 and 2A of the drawings. In the present form of the invention, each of the ground engaging roller assemblies 36 comprises a modified 12,000 Lbs (5,450 kg) capacity manually operated trailer jack assembly 38. Jack assembly 38 is bolted on top of a 13,200 Lbs (6,000 kg) capacity skate assembly 40 that includes four spaced apart swiveling rollers 41 (FIGS. 9 and 10). Welded to the body of the jack assembly is a horizontal arm 42 to which the connector plate 42a is connected. Connector plate 42a has a plurality of spaced apart keyhole shaped openings 43 (FIGS. 9 and 10) that accept appropriate fasteners that include head and threaded shank portions and function in a conventional manner to interconnect connector plates 42a with connector plates 34.

With the construction thus described, a selected jack screw skate assembly 36 can be rolled up to a selected connector plate 34 and cranked up or down to level the larger diameter opening of the keyhole shaped openings 43 of the connector plate 44a with the heads of the threaded fasteners. The jack screw skate assembly 38 can then be rolled forward over the fastener heads until the two mounting plates mate. The jack screw skate assembly can then be cranked up to move the slots of the keyholes over the threaded body of the threaded fasteners. The threaded fasteners can then be tightened to secure the jack screw skate assembly 36 to the frame 12. Advantageously, because of the novel design of the connector plates, when attaching and removing the jack screw skate assemblies, it is not necessary to remove the fasteners, only to loosen them.

Jack assembly 38 is readily commercially available from several sources including Northern Tool Equipment Company of Burnsville, Minn. Similarly, rotating skate assembly 40 is readily commercially available from a number of sources including Amital USA, Inc. of Monroe, N.C. The operation of these assemblies will be described in greater detail hereinafter.

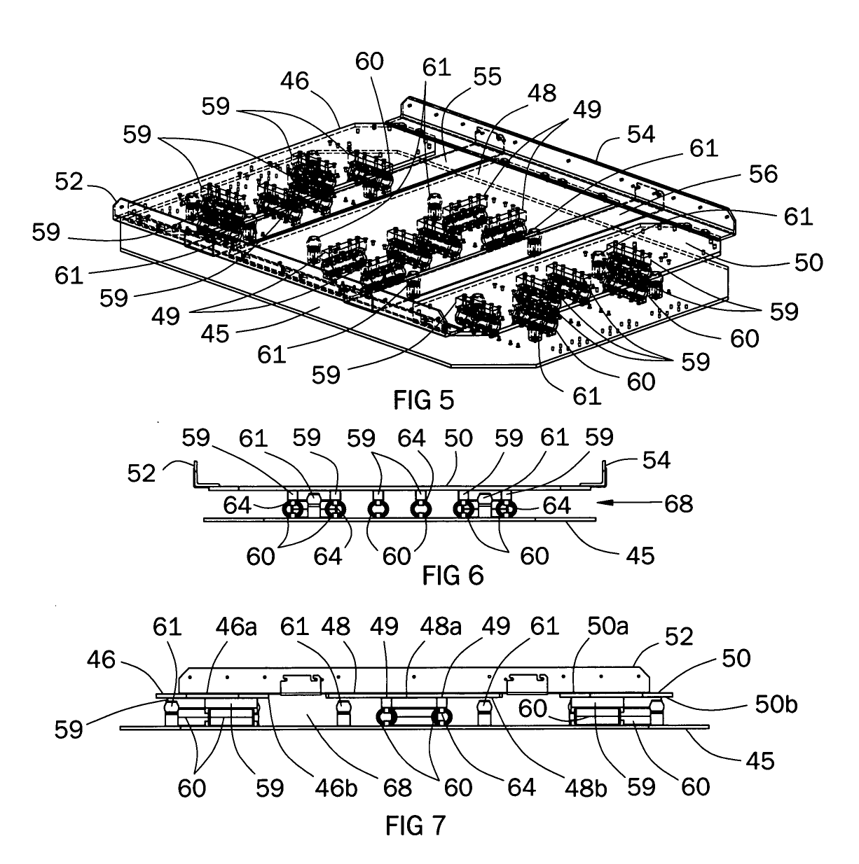

As best seen by referring to FIGS. 2, 5, 6 and 7 of the drawings, the important article support assembly 14 of the present invention comprises a lower, generally planar base plate 45 and three longitudinally spaced apart, generally planar load support panels 46, 48 and 50 that are superimposed over planar base plate 45 and are affixed proximate their ends to transversely spaced apart, elongated right angle members 52 and 54 (see FIG. 5). Disposed between panel 46 and panel 48 is a transverse space 55 and disposed between panel 48 and panel 50 is a transverse space 56. In a manner presently to be described, the edges of planar base plate 45 are connected to base assembly 12 by means of spaced apart connecter block assemblies 57 that are affixed to planar base plate 30 (see FIGS. 3 and 4).

As best seen in FIG. 7, support panel 46 has an upper surface 46a and a lower surface 46b. Similarly, support panel 48 has an upper surface 48a and a lower surface 48b and support panel 50 has an upper surface 50a and a lower surface 50b (see FIG. 7). Connected to and extending upwardly from the upper surface 46a of support panel 46 are four, transversely spaced apart positioning blocks 58 (FIG. 2A), the purpose of which will presently be described. Connected to and disposed below the lower surface 48b of support panel 48 are six, spaced apart, spacer blocks 49, four of which extend transversely and two of which extend longitudinally (FIGS. 5 and 7). The purpose of these important spacer blocks will presently be described. Also connected to and extending upwardly from the upper surface 48a of support panel 48, are two transversely spaced apart positioning blocks 58 (FIG. 2A). Connected to and extending upwardly from the upper surface 50a of support panel 50 are four transversely spaced apart positioning blocks 58 (FIGS. 2 and 2A). Connected to and disposed below the lower surfaces 46b and 50b of each of the support panels 46 and 50 are six transversely spaced apart, staggered spacer blocks 59 (FIGS. 5 and 7). Also connected to and disposed below the lower surfaces of each of the support panels 46, 48 and 50 are four spaced apart, resilient bumper assemblies 61, the purpose of which will presently be described.

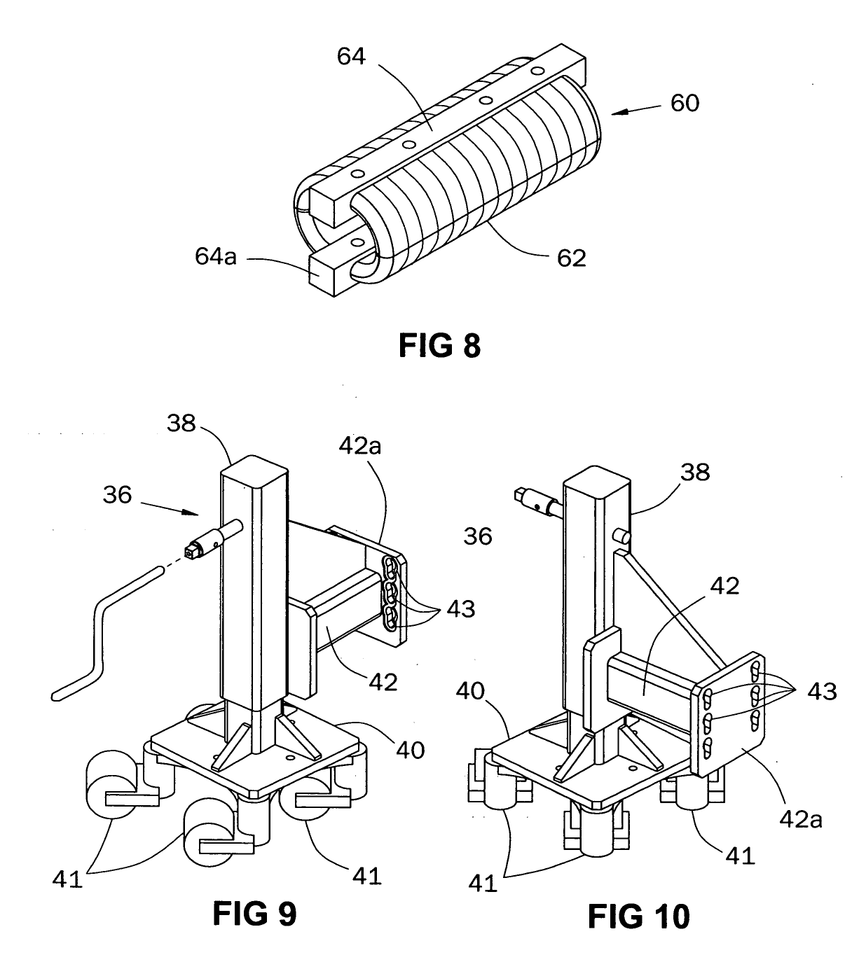

Connected to each of the spacer blocks 49 and 59 and forming a part of the article support assembly 14 is a shock and vibration absorption member shown here as a resilient, energy dissipating isolator assembly 60 (FIG. 8). Isolator assemblies 60, which form an important aspect of the apparatus of the present invention, here comprise stable mounting assemblies of high quality stranded wire rope 62 held with upper and lower rugged metal retainers 64 and 64a (FIG. 8). Connector blocks 49 and 59 are affixed to the upper retainers 64 of the isolating elements in the manner depicted in FIGS. 5 and 7.

Isolator assemblies 60, which uniquely can handle both shock and vibration, have specific response characteristics determined by the diameter of the wire rope, the number of strands, the cable length, the cable twist or lay, and the number of cables per section. Under load inherent damping is provided by flexure hysteresis, i.e., the rubbing and sliding friction between the strands of the wire rope. The novel design of the isolators permits their use in any attitude. Their relatively large dynamic displacement attenuates heavy shocks, while their inherent damping enables them to store and dissipate large amounts of low and high frequency vibration. Further, the damping capacity of the isolators effectively dissipates energy and rapidly decays the response oscillations produced by the initial shock. By keeping the number of oscillations and their peak amplitude to a minimum, the isolators provide a highly beneficial effect on the protected equipment. Advantageously, the isolators are generally unaffected by environmental conditions such as changing temperatures and corrosive media and once installed, require little or no maintenance and typically exhibit a long useful life.

Planar base plate 45 and load support panels 46, 48 and 50 cooperate to define there between an internal space 68. Within internal space 68 and aligned with transverse spaces 55 and 56 are two longitudinally spaced apart transverse lift members receiving channels 70 and 72 (FIG. 2A), the purpose of which will be described hereinafter.

Affixed to end wall 20a in the manner indicated in FIG. 3 is a pair of transversely spaced apart hoist rings 74 and affixed to end wall 20b in the manner indicated in FIG. 3 is a pair of transversely spaced apart hoist rings 76. The purpose of these hoist rings will presently be described.

Prior to loading the cargo to be transported onto the pallet assembly 11, the number of isolating assemblies 60 of the transport pallet can be adjusted to suit the weight of the cargo and its center of gravity. This is accomplished by removing the three longitudinally spaced apart, generally planar support panels 46, 48 and 50 from the article support assembly 14 and then removing from the panels the spacer blocks 49 and 59 that engage each isolating assembly 60 that is to be rendered inactive. To prevent accidental loss of the spacer blocks, they can be bolted to the end of the base panels 45 using taped holes provided for this purpose.

In order to adjust the transport pallet in an alternate manner to accommodate various cargo weights, spacer blocks of different selected widths can be connected to the isolating assemblies, thereby adjusting the resilience of the energy dissipating isolator assemblies.

Next, the article support assembly 14 is re-secured within the base assembly 12 using the previously identified connecter block assemblies 57. In this regard, each connecter block assembly 57 here comprises a connecter block 57a and a strap clamp 57b (FIG. 4), which is pivotally connected to the top of the connecter block and which functions to secure the article support assembly in position. More particularly, with the article support assembly 14 nested within the connecter block assemblies 57, the strap clamps 57b are rotated 90 degrees to cause them to be moved over and into engagement with the generally planar base plate 45 of the article support assembly 14.

With the article support assembly 14 re-secured within the base assembly 16, the transport pallet can be positioned to enable the cargo to be safely loaded onto the article support assembly 14. While the particular method to be used to load the cargo onto the transport pallet depends on the nature of the cargo, typically the cargo is raised by any suitable means of a character well understood by those skilled in the art and the transport pallet is rolled under the elevated cargo. To provide for maximum stability of the transport pallet during cargo loading, the frame 16 of the base assembly 12 is lowered to the ground through use of the four jack assemblies 38. This step is accomplished by first connecting a suitable crank handle 80 to each of the drives 38d of the jack assemblies (see FIG. 9). This done, using a person stationed at each jack assembly, the jack assemblies are simultaneously lowered by controllably rotating the crank handles. Preferably, during this step, one person will count out loud the number of revolutions of the crank handle so that all four people stay at the same revolution, thereby keeping the load level equal.

As illustrated in FIG. 2, as the cargo is lowered into position, the previously identified positioning blocks 58 which are mounted on the upper surfaces of the planar support panels, function to strategically locate the cargo within the article support assembly 14. To secure the cargo within the article support assembly 14, conventional clamp down type restraining assemblies 82 (FIGS. 1 and 2) which are also mounted on the upper surfaces of the planar support panels, are provided as may be required. In practice, the positioning blocks 58 and the restraining assemblies 82 can be moved to different locations on the support panels to suit various cargo dimensions.

With the cargo loaded onto and secured to the transport pallet, the frame 16 of the base assembly 12 is controllably raised by the four persons stationed at each jack assembly simultaneously rotating the crank handles in a frame raising direction.

Prior to loading the transport pallet into the transport vehicle, the rigging crew must create a level transition across the gap between the transport vehicle and the loading dock. This is normally accomplished with large steel and plastic sheets that are taped to the floor of the loading dock. After determining the estimated overall weight of the loaded transport pallet, the vehicle operator must determine the exact position of the loaded transport pallet within the transport vehicle and prepare the necessary tie down equipment needed to secure the cargo.

Because of the weight of the cargo, which, in some cases can exceed 22,000 pounds, industrial class fork lift trucks are required to move the loaded pallet toward the transport truck. The forklift can be suitably connected to the hoist rings 74 of the base assembly with the chains and load binders of a conventional nature so that the forklift can pull, push, and steer the cart as may be required. Similarly, a pair of hoist rings 75 are provided at each end of the base assembly to enable the assembly to be lifted using forklifts or other lifting equipment (FIG. 4). Using an appropriate fork lift truck, the forklift driver will maneuver the loaded pallet cart until it is lined up for a straight entry into the transport vehicle. To prevent damage to the transport vehicle, an adjustable rigid caster 86 is provided on each of the angularly extending wall segments 22 located at each corner of the cart. As shown in FIG. 2 of the drawings, casters 86 extend past the long side of the base assembly 12 so that they will contact the inside walls of the transport vehicle to help guide the assembly and prevent the sides of the assembly from damaging the walls. Casters 86 can be readily adjusted to accommodate transport vehicle openings of various widths. After verifying that the casters 86 are correctly mounted so that they will safely enter the entrance to the transport vehicle, the forklift driver can push the cart into the transport vehicle to the tie down location. With the transport pallet properly positioned within the transport vehicle, the frame 16 of the base assembly 12 is lowered to the floor of the transport vehicle through use of the four jack assemblies 38 in the manner previously described.

Removal of the cargo from the pallet assembly at the cargo destination can be accomplished in two ways. In one case the cargo can be removed directly from the pallet assembly and lowered onto the air bearings or dollies that can be used to move it to its next location. Alternatively, the cargo can remain on the article support assembly of the transport pallet, while the article support assembly along with the cargo is lifted from the base assembly. In this case, the article support assembly along with the cargo can be lowered onto air bearings or dollies and moved to another location where, at a later time, the cargo can be lifted from the article support assembly.

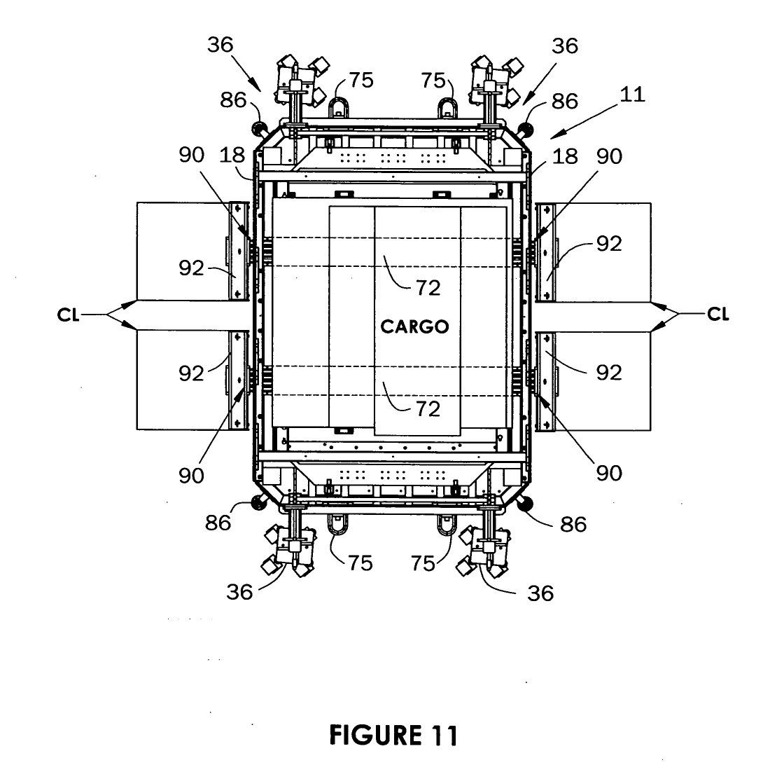

In the instance where the article support assembly along with the cargo is removed from the base assembly, it is necessary to remove the cover plates 24 from the frame 16 to expose the previously identified pair of spaced apart U-shaped openings 25. As previously mentioned, center U-shaped brackets 26a can be used to pick up the heavy cover plate using a forklift and the four inverted U-shaped brackets 26a can be used as tie down points. With the cover plates 24 removed, two elongate lifting bars 90 are first inserted through the transverse lift member receiving channels 70 and 72 so that an equal amount of each lifting bar protrudes from each of the side walls 18a and 18b of the frame 16 (see FIG. 11). This done, a specially designed lifting fixture 92 is connected to each of the protruding ends of the lifting bars in the manner indicated in FIG. 2A of the drawings. Next, four readily commercially available battery operated mobile column lifters “CL”, such as column lifters of the character available from Stertil-Koni of Stevensville, Md. and sold under the Model designation “ST1082”, are mated with the lifting fixtures 92 and then used to lift the lifting bars. More particularly, a selected one of each of the four column lifters “CL” is first rolled into proximity with one of the lift fixtures 92 and then the lifting member of the column lifter is telescopically mated with the lift fixture 92 in a manner well understood by those skilled in the art (See also FIG. 11). Preferably, each of the four lifters should be engaged with its respective lift fixture until the base of the column lifter is approximately one inch from the side of the frame 12.

With the column lifters mated with the lifting fixtures 92 the base plate 45 of the article support assembly 14 can be disconnected from the base assembly 12. This is accomplished by rotating the strap clamps 57b, of the connecter block assemblies 57, 90 degrees to cause them to be moved out of engagement with the generally planar base plate 45 of the article support assembly 14.

This done, the column lifters can be energized to controllably lift the article support assembly 14 along with the cargo from the base assembly 12. With the support assembly 14 in an elevated position, the base assembly 12 can be pulled from beneath the support assembly 14. Then, using the column lifters, the article support assembly 14 along with the cargo can be lowered onto blocks, air bearings or dollies that are of a sufficient height to permit withdrawal of the column lifters and removal of the lifting bars from the article support assembly.

It is to be understood that rather than using column lifters of the character described, lifting and lowering of the article support assembly 14 along with the cargo can be done with a large (30,000+Lbs capacity) forklift truck and a skilled driver. In such case, the forks of the forklift truck, rather than the lifting bars, are inserted into lift member receiving channels 70 and 72 and the forks of the forklift truck accomplish the lifting operations in a manner well understood by those skilled in the art.

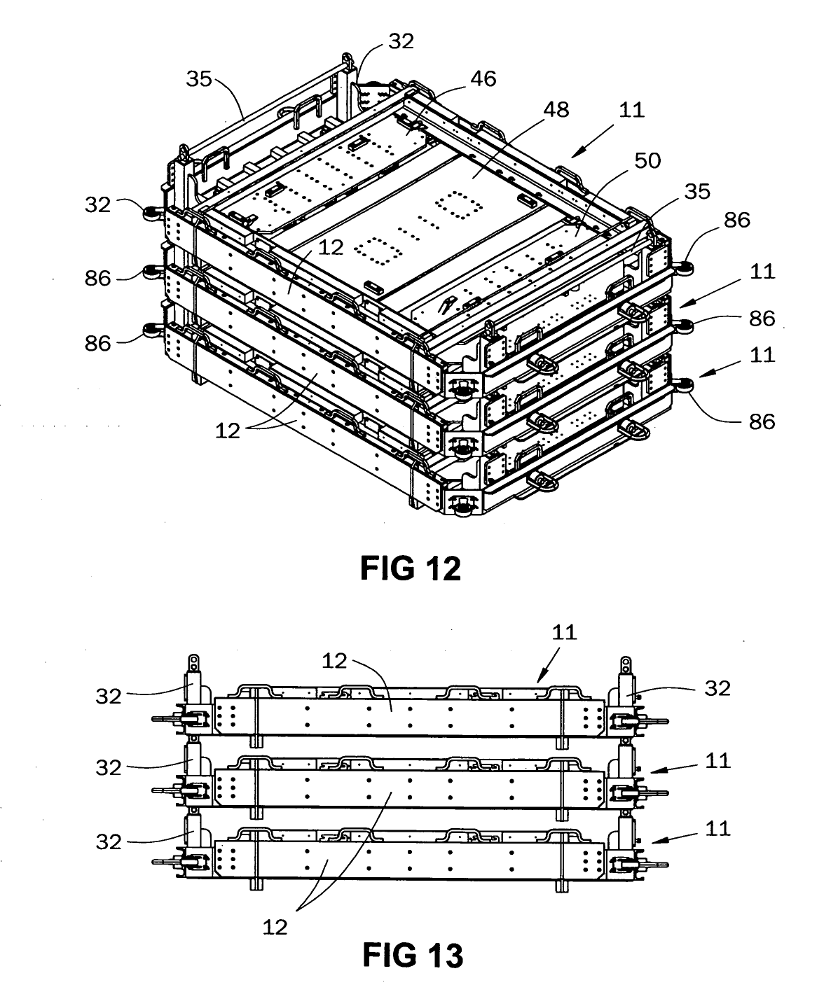

As depicted in FIGS. 12 and 13 of the drawings, when the transport pallets 11 are not in use they can be conveniently stacked for storage or shipment in the manner illustrated so that each assembly rests upon the upstanding members 32 of the assembly immediately beneath it.

Having now described the invention in detail in accordance with the requirements of the patent statues, those skilled in this art will have no difficulty in making changes and modifications in the individual parts or their relative assembly in order to meet specific requirements or conditions. Such changes and modifications may be made without departing from the scope and spirit of the invention, as set forth in the following claims.

1. A transport pallet comprising:
(a) a base assembly including:
(i) frame having interconnected side and end walls;
(ii) a plurality of ground engaging roller assemblies connected to said frame and extending there from; and
(b) an article support assembly connected to said base assembly, said article support assembly including:
(i) a support panel; and
(ii) a plurality of resilient, energy dissipating shock absorbers connected to said support panel.

2. The transport pallet as defined in claim 1 in which each of said plurality of resilient, energy dissipating shock absorbers comprises an upper retainer a lower retainer and a stranded wire rope disposed between said upper and lower retainers.

3. The transport pallet as defined in claim 1 in which said article support assembly further includes a base plate spaced apart from said support panel, said plurality of resilient, energy dissipating shock absorbers connected to said support panel being disposed between said base plate and said at least one article support panel.

4. The transport pallet as defined in claim 1 in which each of said plurality of ground engaging roller assemblies includes a jack assembly and a rotating skate assembly having a plurality of swiveling rollers connected to said jack assembly.

5. The transport pallet as defined in claim 1 in which frame further includes plurality of spaced apart stiffener members connected to and spanning said end walls of said frame.

6. A transport pallet for transporting an article comprising:
(a) a base assembly including:
(i) frame having interconnected side and end walls;
(ii) a plurality of ground engaging roller assemblies connected to said frame and extending there from; and
(b) an article support assembly connected to said base assembly, said article support assembly including:
(i) a base plate;
(ii) a plurality of support panels superimposed over said base plate; and
(iii) a plurality of shock and vibration absorption members disposed between said base plate and said plurality of support panels.

7. The transport pallet as defined in claim 6 in which each of said plurality of shock and vibration absorption members comprises an upper retainer, a lower retainer and a stranded wire rope disposed between said upper and lower retainers.

8. The transport pallet as defined in claim 6 in which each of said plurality of ground engaging roller assemblies includes a jack assembly and a rotating skate assembly having a plurality of swiveling rollers connected to said jack assembly.

9. The transport pallet as defined in claim 6 in which said frame further includes a plurality of transversely spaced apart stiffener members connected to each of said end walls of said frame and in which said article support assembly is supported by said transversely spaced apart stiffener members.

10. The transport pallet as defined in claim 6 in which each of said side walls of said frame is provided with a pair of spaced apart generally U-shaped openings.

11. The transport pallet as defined in claim 6 in which said article support assembly further includes a plurality of transversely spaced apart positioning blocks connected to said support panels for positioning the article on said support panels.

12. The transport pallet as defined in claim 6 in which said frame further comprises a plurality of connecter block assemblies connected to said base panel of said frame for connecting said base plate of said article support assembly to said frame.

13. The transport pallet as defined in claim 6 in which said frame further includes angularly extending wall segments located at the juncture of said interconnected side and end walls.

14. The transport pallet as defined in claim 13 in which said frame further includes a rigid caster connected to each of said angularly extending wall segments of said frame.

15. A transport pallet for transporting an article comprising:
(a) a base assembly including:
(i) frame having interconnected side and end walls;
(ii) a plurality of ground engaging roller assemblies connected to said frame and extending there from, each of said plurality of ground engaging roller assemblies including a jack assembly and a rotating skate assembly having a plurality of swiveling rollers connected to said jack assembly; and
(b) an article support assembly connected to said base assembly, said article support assembly including:
(i) a base plate;
(ii) a plurality of support panels superimposed over said base plate; and
(iii) a plurality of a shock and vibration absorption members disposed between said base plate and said plurality of support panels each of said plurality of shock and vibration absorption members comprising an upper retainer, a lower retainer and a stranded wire rope disposed between said upper and lower retainers.

16. The transport pallet as defined in claim 15 further including a spacer member connected to each of said upper retainer of each of said plurality of shock and vibration absorbtion members.

17. The transport pallet as defined in claim 15 in which said frame further includes a plurality of transversely spaced apart stiffener members connected to each of said end walls of said frame and in which said article support assembly is supported by said transversely spaced apart stiffener members.

18. The transport pallet as defined in claim 17 in which each of said side walls of said frame is provided with a pair of spaced apart generally U-shaped openings.

19. The transport pallet as defined in claim 17 in which said article support assembly further includes a plurality of transversely spaced apart positioning blocks connected to said support panels for positioning the article on said support panels.

20. The transport pallet as defined in claim 19 in which said frame further comprises a plurality of connecter block assemblies connected to said base panel of said frame for connecting said base plate of said article support assembly to said frame, each said connecter block assembly comprising a connecter block and a strap clamp connected to said connecter block.

21. The transport pallet as defined in claim 20 in which said frame further includes:
(a) an angularly extending wall segment located between each of said side and end walls of said frame; and
(b) a caster connected to and extending from each of said angularly extending wall segments of said frame.
